(19) United States
(12) Patent Application Publication
(10) Pub. No.: US 2024/0305385 A1
(43) Pub. Date: Sep. 12, 2024

(54) OPTICAL POWER FEEDING SYSTEM

(71) Applicant: KYOCERA CORPORATION, Kyoto-shi, Kyoto (JP)

(72) Inventor: Takehiko SUYAMA, Yamato-shi, Kanagawa (JP)

(21) Appl. No.: 17/754,855

(22) PCT Filed: Aug. 28, 2020
(86) PCT No.: PCT/JP2020/032576

§ 371 Date: Apr. 14, 2022

(30) Foreign Application Priority Data
Oct. 18, 2019 (JP) 2019-190636

(51) Int. Cl. H04B 10/80; G08C 23/06

(52) U.S. Cl. CPC H04B 10/807; G08C 23/06

(57) ABSTRACT

A power over fiber system includes power sourcing equipment that outputs power feed light, and a powered device that converts the power feed light from the power sourcing equipment into electric power. The power sourcing equipment includes a power feed control unit that, while causing the power feed light to be output as a light pulse, performs digital modulation on the light pulse and superimposes predetermined information on the power feed light.

### RELATED APPLICATIONS

The present application is a National Phase of International Application No. PCT/JP2020/032576 filed Aug. 28, 2020, which claims priority to Japanese Application No. 2019-190636, filed Oct. 18, 2019.

### TECHNICAL FIELD

The present disclosure relates to optical power feed.

### BACKGROUND ART

Studies have recently been made on an optical power feeding system that converts electric power into light (referred to as power feed light), transmits the power feed light, converts the power feed light into electric energy, and uses the electric energy as electric power.

PTL 1 describes an optical communication device including a light transmitter that transmits signal light modulated by an electric signal and power feed light for feeding electric power; an optical fiber including a core that transmits the signal light, a first clad that is formed around the core, that has a smaller refractive index than the core, and that transmits the power feed light, and a second clad that is formed around the first clad and that has a smaller refractive index than the first clad; and a light receiver that is operated by electric power generated by converting the power feed light transmitted through the first clad of the optical fiber and that converts the signal light transmitted through the core of the optical fiber into the electric signal.

### CITATION LIST

### Patent Literature

PTL 1: Japanese Unexamined Patent Application Publication No. 2010-135989

### SUMMARY OF INVENTION

### Technical Problem

In the technique described in PTL 1 mentioned above, it is necessary to transmit signal light separately from power feed light in the case of transmitting data together with electric power.

### Solution to Problem

An optical power feeding system according to an aspect of the present disclosure is
an optical power feeding system including power sourcing equipment that outputs power feed light, and a powered device that converts the power feed light from the power sourcing equipment into electric power, in which
the power sourcing equipment includes a power feed control unit that, while causing the power feed light to be output as a light pulse, performs digital modulation on the light pulse and superimposes predetermined information on the power feed light.

### BRIEF DESCRIPTION OF DRAWINGS

FIG. 1 is a configuration diagram of a power over fiber (PoF) system according to a first embodiment of the present disclosure.

FIG. 2 is a configuration diagram of a PoF system according to a second embodiment of the present disclosure.

FIG. 3 is a configuration diagram of the PoF system according to the second embodiment of the present disclosure and illustrates optical connectors and so forth.

FIG. 4 is a configuration diagram of a PoF system according to another embodiment of the present disclosure.

FIG. 5 is a configuration diagram of a PoF system according to a third embodiment of the present disclosure.

FIG. 6A is a diagram for describing digital modulation performed by a power feed control unit of the PoF system according to the third embodiment of the present disclosure.

FIG. 6B is a diagram for describing digital modulation performed by the power feed control unit of the PoF system according to the third embodiment of the present disclosure.

FIG. 7 is a configuration diagram of a PoF system according to a fourth embodiment of the present disclosure.

### DESCRIPTION OF EMBODIMENTS

Hereinafter, an embodiment of the present disclosure will be described with reference to the drawings.

### (1) Overview of System

### First Embodiment

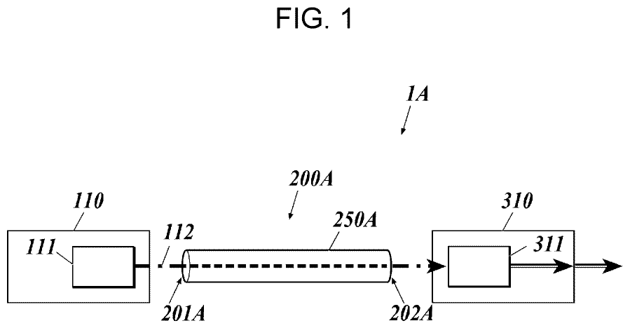

As illustrated in FIG. 1, a power over fiber (PoF) system 1A of the present embodiment includes power sourcing equipment (PSE) 110, an optical fiber cable 200A, and a powered device (PD) 310.

In the present disclosure, power sourcing equipment is equipment that converts electric power into optical energy and supplies the optical energy, and a powered device is a device that is supplied with optical energy and converts the optical energy into electric power.

The PSE 110 includes a power feeding semiconductor laser 111.

The optical fiber cable 200A includes an optical fiber 250A serving as a transmission path of power feed light.

The PD 310 includes a photoelectric conversion element 311.

The PSE 110 is connected to a power source, and the power feeding semiconductor laser 111 and so forth are electrically driven.

The power feeding semiconductor laser 111 lases using electric power from the power source, and outputs power feed light 112.

The optical fiber cable 200A has a one end 201A connectable to the PSE 110 and an other end 202A connectable to the PD 310, and transmits the power feed light 112.

The power feed light 112 from the PSE 110 is input to the one end 201A of the optical fiber cable 200A, propagates through the optical fiber 250A, and is output from the other end 202A to the PD 310.

The photoelectric conversion element 311 converts the power feed light 112 transmitted through the optical fiber cable 200A into electric power. The electric power generated through the conversion by the photoelectric conversion element 311 serves as driving power that is necessary within the PD 310. Furthermore, the PD 310 is capable of outputting the electric power generated through the conversion by the photoelectric conversion element 311 to an external device.

A semiconductor material constituting a semiconductor region having a photoelectric conversion effect of the power feeding semiconductor laser 111 and the photoelectric conversion element 311 is a semiconductor having a short laser wavelength of 500 nm or less.

A semiconductor having a short laser wavelength has a large band gap and high photoelectric conversion efficiency. Thus, the photoelectric conversion efficiency on the power generation side and the power reception side of optical power feed increases, and optical power feed efficiency increases.

Thus, as the semiconductor material, for example, a semiconductor material of a laser medium having a laser wavelength (fundamental wave) of 200 to 500 nm, such as diamond, gallium oxide, aluminum nitride, or GaN, may be used.

As the semiconductor material, a semiconductor having a band gap of 2.4 eV or more is applied.

For example, a semiconductor material of a laser medium having a band gap of 2.4 to 6.2 eV, such as diamond, gallium oxide, aluminum nitride, or GaN, may be used.

Laser light tends to have higher transmission efficiency as the wavelength increases, and have higher photoelectric conversion efficiency as the wavelength decreases. Thus, in the case of long-distance transmission, a semiconductor material of a laser medium having a laser wavelength (fundamental wave) of more than 500 nm may be used. In the case of giving priority to photoelectric conversion efficiency, a semiconductor material of a laser medium having a laser wavelength (fundamental wave) of less than 200 nm may be used.

These semiconductor materials may be applied to either one of the power feeding semiconductor laser 111 and the photoelectric conversion element 311. The photoelectric conversion efficiency on the power feed side or the power reception side increases, and the optical power feed efficiency increases.

### Second Embodiment

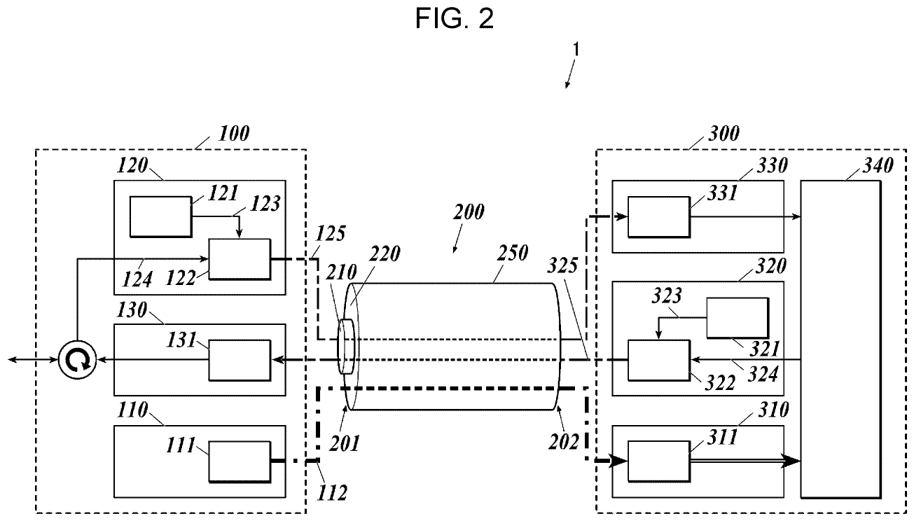

As illustrated in FIG. 2, a PoF system 1 of the present embodiment includes a power feeding system and an optical communication system that use an optical fiber, and includes a first data communication device 100 including PSE 110, an optical fiber cable 200, and a second data communication device 300 including a PD 310.

The PSE 110 includes a power feeding semiconductor laser 111. The first data communication device 100 includes, in addition to the PSE 110, a transmission unit 120 that performs data communication, and a reception unit 130. The first data communication device 100 corresponds to data terminal equipment (DTE), a repeater, or the like. The transmission unit 120 includes a signal semiconductor laser 121 and a modulator 122. The reception unit 130 includes a signal photodiode 131.

The optical fiber cable 200 includes an optical fiber 250 including a core 210 serving as a transmission path of signal light and a clad 220 disposed around the perimeter of the core 210 and serving as a transmission path of power feed light.

The PD 310 includes a photoelectric conversion element 311. The second data communication device 300 includes, in addition to the PD 310, a transmission unit 320, a reception unit 330, and a data processing unit 340. The second data communication device 300 corresponds to a power end station or the like. The transmission unit 320 includes a signal semiconductor laser 321 and a modulator 322. The reception unit 330 includes a signal photodiode 331. The data processing unit 340 is a unit that processes a received signal. The second data communication device 300 is a node in a power feed network. Alternatively, the second data communication device 300 may be a node that communicates with another node.

The first data communication device 100 is connected to a power source, and the power feeding semiconductor laser 111, the signal semiconductor laser 121, the modulator 122, the signal photodiode 131, and so forth are electrically driven. The first data communication device 100 is a node in the power feed network. Alternatively, the first data communication device 100 may be a node that communicates with another node.

The power feeding semiconductor laser 111 lases using electric power from the power source, and outputs power feed light 112.

The photoelectric conversion element 311 converts the power feed light 112 transmitted through the optical fiber cable 200 into electric power. The electric power generated through the conversion by the photoelectric conversion element 311 serves as driving power of the transmission unit 320, the reception unit 330, and the data processing unit 340, and also driving power that is necessary within the second data communication device 300. Furthermore, the second data communication device 300 may be capable of outputting the electric power generated through the conversion by the photoelectric conversion element 311 to an external device.

On the other hand, the modulator 122 of the transmission unit 120 modulates, based on transmission data 124, laser light 123 from the signal semiconductor laser 121, and outputs the resultant light as signal light 125.

The signal photodiode 331 of the reception unit 330 demodulates the signal light 125 transmitted through the optical fiber cable 200 into an electric signal, and outputs the electric signal to the data processing unit 340. The data processing unit 340 transmits data corresponding to the electric signal to a node, whereas receives data from the node and outputs the data as transmission data 324 to the modulator 322.

The modulator 322 of the transmission unit 320 modulates, based on the transmission data 324, laser light 323 from the signal semiconductor laser 321, and outputs the resultant light as signal light 325.

The signal photodiode 131 of the reception unit 130 demodulates the signal light 325 transmitted through the optical fiber cable 200 into an electric signal, and outputs the electric signal. Data corresponding to the electric signal is transmitted to a node, whereas data from the node is regarded as the transmission data 124.

The power feed light 112 and the signal light 125 from the first data communication device 100 are input to a one end 201 of the optical fiber cable 200, the power feed light 112 propagates through the clad 220, the signal light 125 propagates through the core 210, and the power feed light 112 and the signal light 125 are output from an other end 202 to the second data communication device 300.

The signal light 325 from the second data communication device 300 is input to the other end 202 of the optical fiber cable 200, propagates through the core 210, and is output from the one end 201 to the first data communication device 100.

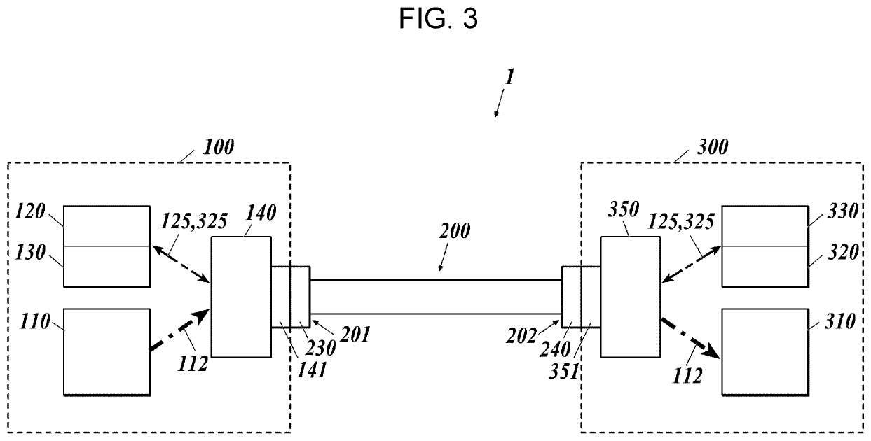

As illustrated in FIG. 3, the first data communication device 100 is provided with a light input/output unit 140 and an optical connector 141 attached thereto. The second data communication device 300 is provided with a light input/output unit 350 and an optical connector 351 attached thereto. An optical connector 230 provided at the one end 201 of the optical fiber cable 200 is connected to the optical connector 141. An optical connector 240 provided at the other end 202 of the optical fiber cable 200 is connected to the optical connector 351. The light input/output unit 140 guides the power feed light 112 to the clad 220, guides the signal light 125 to the core 210, and guides the signal light 325 to the reception unit 130. The light input/output unit 350 guides the power feed light 112 to the PD 310, guides the signal light 125 to the reception unit 330, and guides the signal light 325 to the core 210.

As described above, the optical fiber cable 200 has the one end 201 connectable to the first data communication device 100 and the other end 202 connectable to the second data communication device 300, and transmits the power feed light 112. Furthermore, in the present embodiment, the optical fiber cable 200 bidirectionally transmits the signal light 125 and the signal light 325.

As a semiconductor material constituting a semiconductor region having a photoelectric conversion effect of the power feeding semiconductor laser 111 and the photoelectric conversion element 311, a semiconductor material similar to that of the above-described first embodiment is applied, and high optical power feed efficiency is realized.

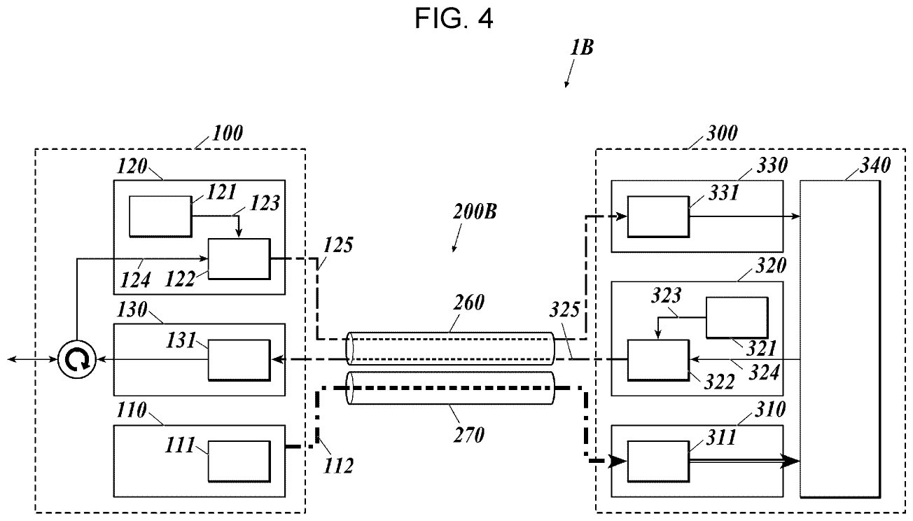

As in an optical fiber cable 200B of a PoF system 1B illustrated in FIG. 4, an optical fiber 260 that transmits signal light and an optical fiber 270 that transmits power feed light may be separately provided. The optical fiber cable 200B may be made up of a plurality of cables.

### (2) Power Feed Control Unit

Next, a power feed control unit that controls power feed will be described.

### Third Embodiment

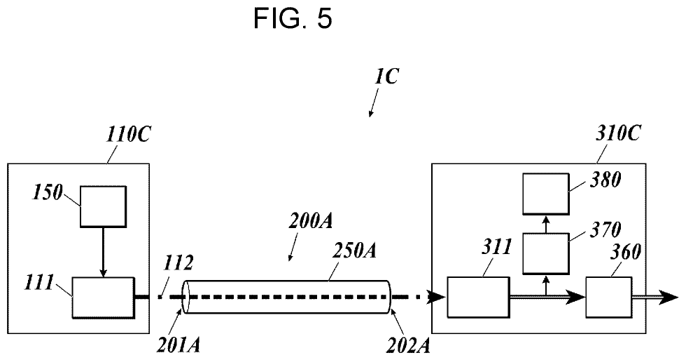

FIG. 5 is a configuration diagram of a PoF system of a third embodiment to which a power feed control unit is applied. In FIG. 5, the same elements as those described above are denoted by the same reference numerals, and the detailed description thereof is omitted.

As illustrated in FIG. 5, a PoF system 1C of the third embodiment includes PSE 110C, an optical fiber cable 200A, and a PD 310C.

The PSE 110C includes, in addition to the power feeding semiconductor laser 111, a power feed control unit 150.

The power feed control unit 150 controls lasing of the power feeding semiconductor laser 111 and controls output of power feed light 112. The power feed control unit 150 transmits a laser output of the power feed light 112 as a light pulse.

The power feed control unit 150 digitally modulates the light pulse and superimposes predetermined information on the power feed light 112.

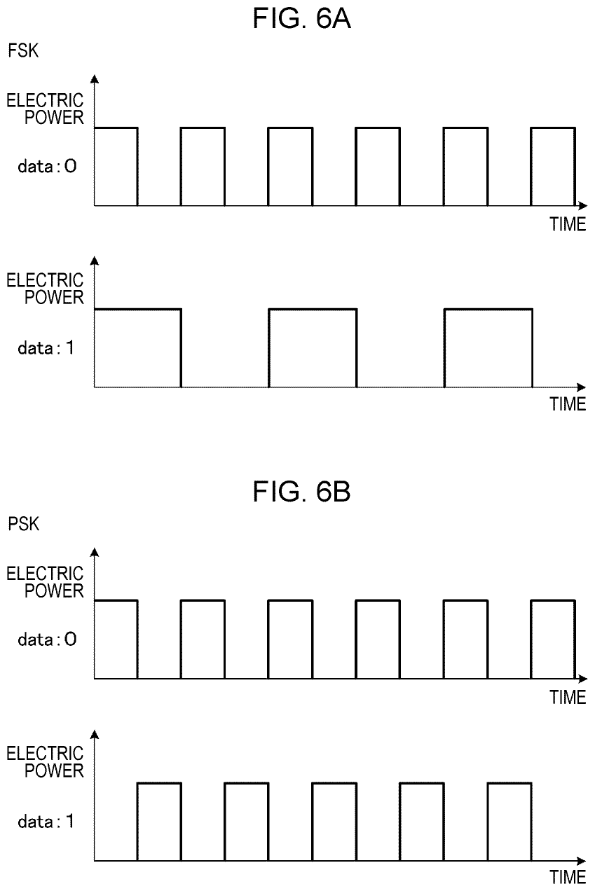

The digital modulation scheme is not particularly limited. However, frequency-shift keying (FSK) for changing a frequency with a duty ratio being fixed, as illustrated in FIG. 6A, or phase-shift keying (PSK) for changing a phase with a frequency being fixed, as illustrated in FIG. 6B, is preferred. With use of these digital modulation schemes, information can be superimposed without changing an amount of power feed. FIG. 6A and FIG. 6B each illustrate an example of a binary signal (modulation of only one bit per symbol). Alternatively, higher-order modulation may be performed by using frequencies or phases of a larger number of stages.

The information to be superimposed on the power feed light 112 is not particularly limited, but relatively light data is appropriate. For example, the information may be a signal for notifying the PD 310C of a power transmission state of the PSE 110C (for example, notifying that an amount of power feed will be increased), or a signal for controlling a device in the PD 310C (for example, switching a photoreception diode).

As illustrated in FIG. 5, the PD 310C includes, in addition to the photoelectric conversion element 311, a power smoothing circuit 360, a demodulation circuit 370, and a control unit 380.

The power smoothing circuit 360 smooths electric power generated by converting the power feed light 112 by the photoelectric conversion element 311, and supplies the smoothed electric power to a load. The load may be each device in the PD 310C or may be an external device.

The demodulation circuit 370 demodulates the light pulse of the power feed light 112 and acquires the superimposed information. The acquired information is transmitted to the control unit 380.

The control unit 380 controls, based on the information received from the demodulation circuit 370, the individual units of the PD 310C.

In this way, while the power feed light 112 is output as a light pulse, the light pulse is digitally modulated and predetermined information is superimposed on the power feed light 112. Accordingly, data transmission can be easily performed together with power transmission.

### Fourth Embodiment

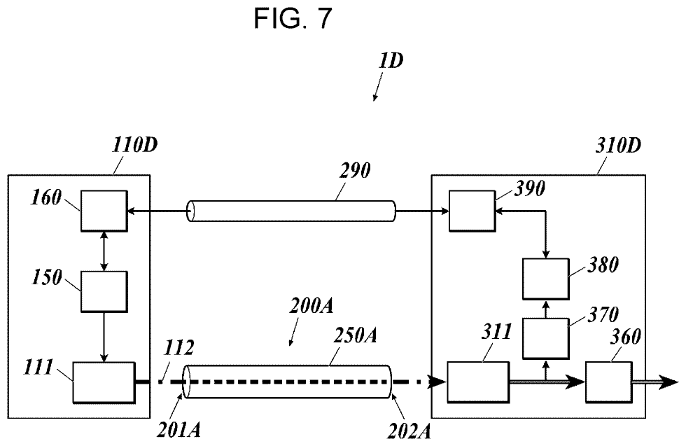

FIG. 7 is a configuration diagram of a PoF system of a fourth embodiment to which a power feed control unit is applied. In FIG. 7, the same elements as those described above are denoted by the same reference numerals, and the detailed description thereof is omitted.

As illustrated in FIG. 7, a PoF system 1D of the fourth embodiment is different from the PoF system 1C of the third embodiment mainly in including a dedicated communication line.

The PoF system 1D includes PSE 110D and a PD 310D.

The PSE 110D and the PD 310D are provided with a communication line for data communication, separately from a power feed line similar to that of the PoF system 1C of the above-described third embodiment.

The communication line of the PoF system 1D includes a first communicator 160, a communication cable 290, and a second communicator 390.

The first communicator 160 and the second communicator 390 perform data communication with each other through the communication cable 290. The first communicator 160 is provided in the PSE 110D and is controlled by a power feed control unit 150. The second communicator 390 is provided in the PD 310D and is controlled by a control unit 380. The first communicator 160 and the second communicator 390 may communicate with an outside of the system.

The power feed line of the PoF system 1D has a configuration similar to that of the PoF system 1C of the above-described third embodiment. That is, in the PSE 110D, output of power feed light 112 is controlled by the power feed control unit 150.

As in the above-described third embodiment, while causing the power feed light 112 to be output as a light pulse, the power feed control unit 150 digitally modulates the light pulse and superimpose predetermined information on the power feed light 112.

The information to be superimposed on the power feed light 112 includes information similar to that of the above-described third embodiment, and a signal for notifying the PD 310D of the state of the PSE 110D in an idle mode. The idle mode is a state in a preparatory stage before the system is activated. The PoF system 1D shifts from the idle mode to an active mode in which the power feed line and the communication line function. Alternatively, the information may be used to report the state of an inactive mode in a suspension state that occurs after the shift to the active mode.

Accordingly, notification of the state of the PSE 110D can be performed together with power transmission using the power feed light 112, and the operation of the PD 310D can be controlled based on the notification. Thus, operation control of the PD 310D based on the state of the PSE 110D can be easily performed without using the communication line.

The communication line of the PoF system 1D is not limited to that described above. For example, a single optical fiber may be used as a communication line and a power feed line as illustrated in FIG. 2, or different optical fibers may be used as a communication line and a power feed line as illustrated in FIG. 4.

While the embodiments of the present disclosure have been described above, the embodiments have been given as examples, and other various embodiments can be made. The elements may be omitted, replaced, or changed without deviating from the gist of the invention.

### INDUSTRIAL APPLICABILITY

As described above, an optical power feeding system according to the present invention is useful to realize power feed in which data transmission can be easily performed together with power transmission.

1. An optical power feeding system comprising:
power sourcing equipment configured to output power feed light; and
a powered device configured to convert the power feed light from the power sourcing equipment into electric power, wherein
the power sourcing equipment includes a power feed control unit that, while causing the power feed light to be output as a light pulse, is configured to perform digital modulation on the light pulse and superimposes predetermined information on the power feed light.

2. The optical power feeding system according to claim 1, wherein the digital modulation is frequency-shift keying or phase-shift keying.

3. The optical power feeding system according to claim 1, wherein the predetermined information is a signal for notifying the powered device of a power transmission state of the power sourcing equipment or a signal for controlling a device in the powered device.

4. The optical power feeding system according to claim 1, wherein the powered device includes
a demodulation circuit that demodulates the light pulse and acquires the superimposed information, and
a control unit configured to control the powered device, based on the information acquired by the demodulation circuit.

5. The optical power feeding system according to claim 1, comprising:
an optical fiber configured to transmit the power feed light between the power sourcing equipment and the powered device; and
a communication cable for performing data communication between the power sourcing equipment and the powered device.

6. The optical power feeding system according to claim 5, wherein the predetermined information includes a signal for notifying the powered device of a state of the power sourcing equipment in an idle mode.
